(19) United States
(12) Patent Application Publication
(10) Pub. No.: US 2026/0200672 A1
(43) Pub. Date: Jul. 16, 2026

(54) LIFT ARRANGEMENT AND METHOD FOR MOVING A STORAGE CONTAINER IN A MULTIFRAMEWORK STORAGE SYSTEM

(71) Applicant: AutoStore Technology AS, Nedre Vats (NO)

(72) Inventor: Jørgen Djuve Heggebø, Langhus (NO)

(21) Appl. No.: 19/135,174

(22) PCT Filed: Nov. 23, 2023
(86) PCT No.: PCT/EP2023/082833

§ 371 Date: Jun. 3, 2025

(30) Foreign Application Priority Data
Dec. 5, 2022 (NO) 20221302

(51) Int. Cl. B65G 1/04

(52) U.S. Cl. CPC B65G 1/0464; B65G 1/045; B65G 2201/0258

(57) ABSTRACT

The present invention relates to a lift arrangement for moving storage containers between a first framework structure and a second framework structure of an automated storage and retrieval system The lift arrangement comprises a guide extending between at least the first framework structure and the second framework structure and a plurality of container carriers individually movable along the guide between a first container handling position and a second container handling position.

### FIELD OF THE INVENTION

The present invention relates to a lift arrangement for moving storage containers between a first framework structure and a second framework structure of an automated storage and retrieval system. The present invention also relates to an automated storage and retrieval system. The present invention also relates to a method for moving storage containers between a first framework structure and a second framework structure of an automated storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1. The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X-and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing.

These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO2017121515 shows a paternoster type of elevator for moving storage containers from an upper level of a storage system to an access station.

WO2019229170 (AutoStore) shows a storage container lift assembly for moving storage containers between an upper storage framework structure and a lower storage framework structure.

WO2019238659 (AutoStore) shows a lift arrangement for transporting storage containers between levels in a multi-level automated storage and retrieval system.

WO2014075937 (AutoStore) shows a different lift arrangement for moving storage containers between an upper storage framework structure and a lower storage framework structure.

One object of the present invention is to provide an alternative lift arrangement for moving storage containers between a first framework structure and a second framework structure separate from the first framework structure.

In particular, the present invention is to provide an alternative lift arrangement for moving storage containers between an upper framework structure and a lower framework structure.

### SUMMARY OF THE INVENTION

The present invention relates to a lift arrangement for moving storage containers between a first framework structure and a second framework structure of an automated storage and retrieval system, wherein the lift arrangement comprises:
a guide extending between at least the first framework structure and the second framework structure, wherein the guide comprises a first container handling position located within the first framework structure and a second container handling position located within the second framework structure; and
a plurality of container carriers individually movable along the guide between the first container handling position and the second container handling position.

In one aspect, the first container handling position is a position at which a container is loaded from the first framework structure to one of the container carriers or is unloaded from one of the container carriers to the first framework structure and/or wherein the second container handling position is a position at which a container is loaded from the second framework structure to one of the container carriers or is unloaded from one of the container carriers to the second framework structure.

In one aspect, the guide is an endless guide.

As used herein, the term “lift arrangement” refers to transportation of storage containers between two framework structures, wherein the transportation takes place at a level above a ground level. Typically, the ground level will be a floor inside the building in which the framework structure is located. The framework structures are supported by the floors of the buildings in which the framework structures are located.

As used herein, the term “multi-framework” automated storage and retrieval system is a system with two or more framework structures in which storage containers can be stored.

The first framework structure may be separate from the second framework structure.

In one aspect, the first framework structure is located above the second framework structure. In one aspect, the first framework structure is located on a first floor of a building and the second framework structure is located on a second floor of the building, wherein the first floor is located above the second floor. The first floor and/or the second floor may be a mezzanine. The guide may be provided through openings of the floor at which the upper framework structure is supported on.

Alternatively, the first framework structure and the second framework structure are located on a common level. As the lift arrangement is arranged above the common level, the floor below the lift arrangement is available for other purposes.

In one aspect, the endless guide is oriented vertically.

In one aspect, the endless guide comprises a first guide member and a second guide member spaced apart in a horizontal direction from the first guide member, wherein the plurality of container carriers are connected between the first guide member and the second guide member.

In one aspect, the endless guide is a guide rail. In one aspect, the first guide member is a first guide rail and the second guide member is a second guide rail.

In one aspect, the plurality of container carriers are sequentially movable along the endless guide.

In one aspect, the first guide member and the second guide member are parallel to each other. In one aspect, the first guide member and the second guide member are oriented vertically. In one aspect, the first guide member and the second guide member define a path for the movement of the container carriers. In one aspect, the first guide member and the second guide member run in parallel with each other.

In one aspect, the endless guide may comprise a T-shaped or H-shaped profile. In one aspect, the first guide member and the second guide member have a T-shaped or H-shaped cross-sectional profile. In one aspect, the endless guide is rectangular with rounded corners or O-shaped. In one aspect, the first guide member and the second guide member are rectangular with rounded corners or O-shaped.

In one aspect, the plurality of container carriers are individually movable along the endless guide between the first container handling position and the second container handling position in one direction only. Alternatively, the plurality of container carriers are individually movable along the endless guide between the first container handling position and the second container handling position in both directions.

Hence, the container carriers may move in one or both of a first direction and a second direction opposite to the first direction.

As the plurality of container carriers are connected to the endless guide, the sequence of arrival of the plurality of container carriers at the first container handling position and the second container handling position is predetermined, based on their connection to the endless guide relative to other container carriers, and based on their movement direction.

As used herein, the term “individually movable” is used to denote that the movement of each container carrier may be controlled individually. Hence, in a case where the container carriers are allowed to move in the first direction only, then at least one of the container carriers can be controlled to stay stationary while at least one of the other container carriers can be controlled to move in the first direction during the same period of time. Alternatively, in a case where the container carriers are allowed to move in the first direction and in the second direction, then at least one of the container carriers can be controlled to stay stationary while at least one of the other container carriers can be controlled to move in the first direction or to move in the second direction during the same period of time.

In one aspect, each of the plurality of container carriers comprises:
a supporting surface for supporting a storage container;
a drive for moving the supporting surface along the guide;
an orientation device for orienting the supporting surface with respect to the drive during the movement of the container carrier along the guide.

In one aspect, each of the plurality of container carriers comprises a carrier control system for controlling the orientation device and the drive.

In one aspect, each of the plurality of container carriers comprises a runner for connecting the supporting surface to the guide.

In one aspect, the drive comprises powered wheels. The powered wheels may be used also for the purpose of connecting the supporting surface to the guide.

In one aspect, each of the plurality of container carriers comprises a first runner for connecting the supporting surface to the first guide member and a second runner for connecting the supporting surface to the second guide member.

In one aspect, each of the plurality of container carriers comprises a first powered wheel for moving the supporting surface along the first guide member. Each of the plurality of container carriers may comprise a second powered or non-powered wheel for guiding the supporting surface along the second guide member. Hence, one-wheel drive container carriers or two-wheel drive container carriers are possible. Of course, it is also possible to provide the container carriers with more than two wheels.

In one aspect, the guide comprises an electrical contact; wherein the runner comprises an electrical pickup provided in electrical contact with the electrical contact, wherein the drive and/or the orientation device are supplied with electrical power via the electrical pickup and the electrical contact.

In one aspect, the carrier control system of each container carrier is configured to control its associated orientation device to keep the supporting surface in a horizontal orientation during movement of the container carrier around the endless guide.

In one aspect, the orientation device is a servo motor controlled by the carrier control system.

In one aspect, the carrier control system comprises a sensor for sensing the orientation of the supporting surface.

In one aspect, each of the plurality of container carriers comprises:
an axle extending between a first runner and a second runner, wherein the supporting surface is arranged to pivot around the axle by means of the orientation device.

In one aspect, the container carrier comprises a base on which the supporting surface is provided; wherein the axle is extending through an opening provided in the base.

In one aspect, the orientation device is secured to the base. Here, the orientation device is orienting the base, and hence the supporting surface, with respect to the axle during its movement along the endless guide.

In one aspect, the supporting surface comprises pegs for preventing horizontal movement of the storage container relative to the supporting surface. The supporting surface may here support the base of the storage container.

In one aspect, the pegs are corner pegs protruding upwardly from corners of the supporting surface. In one aspect, the pegs are received in a recess or cut-out in the downwardly facing surface of the storage container. Preferably, the pegs ensure that the footprint of the supporting surface is be equal to the footprint of the storage container.

In one aspect, the supporting surface is formed as a rim for supporting an upper part of the storage containers, thereby allowing storage containers of different heights to be supported at the same level.

In one aspect, the storage containers comprise an upper edge protruding out from the top of the storage container, wherein the upper edge is configured to rest on top of the rim when the storage container is carried by the container carrier.

In one aspect, the container carrier comprises a container elevator for elevating the storage container upwardly to a desired height. In one aspect, the lift arrangement has a width being less than or equal to a width of a storage row of the automated storage and retrieval system.

In one aspect, the width of a storage row is equal to a width of a storage column plus widths of rails on each side of the storage column. The width of a storage column is equal to the width of a storage container.

In one aspect, the drive is located at least partially below the supporting surface.

In one aspect, the drive is engaging a surface of the endless guide. In one aspect, the surface of the endless guide engaged by the drive is a smooth surface.

In one aspect, the orientation device is allowing 360° degrees of movement of the supporting surface relative to the runner.

In one aspect, the carrier control system is configured to control the movement of the container carriers at different times and/or at different speeds.

In one aspect, the lift arrangement comprises:
a control system provided in communication with the carrier control systems of the respective container carriers, wherein the control system is configured to prevent collision between the container carriers.

In one aspect, the control system is a control system of the automated storage and retrieval system. Alternatively, the control system is a separate control system provided in communication with the control system of the automated storage and retrieval system.

In one aspect, the carrier control system comprises a sensor for measuring a parameter representative of the position of the container carrier. Alternatively, the lift arrangement comprises one or more sensors for measuring positions for the respective container carriers. The parameter representative of the position of the container carrier may be a position relative to the endless guide. The parameter representative of the position of the container carrier may be a distance between the container carrier and its preceding container carrier and/or a distance between the container carrier and its succeeding container carrier.

In one aspect, the carrier control system may control the distance between an empty container carrier to be closer to an adjacent container carrier than an occupied container carrier. Hence, the distance between empty container carriers may be shorter, reducing the time of moving such empty container carriers to the container handling position.

In one aspect, the carrier control system is configured to stop the movement of the container carrier at the first container handling position and at the second container handling position while moving other container carriers along the endless guide.

In one aspect, the carrier control system is configured to stop the movement of the container carrier at the first container handling position and the second container handling position only if predetermined conditions are met.

In one aspect, the lift arrangement is temporarily storing a container within a framework structure of the automated storage and retrieval system.

The present invention also relates to an automated storage and retrieval system comprising:
a first framework structure comprising upright members and a storage volume comprising storage columns provided between the upright members, wherein storage containers are stackable in stacks within the storage columns; wherein the first framework structure comprises a first rail system supported on the upright members of the first framework structure;
a second framework structure comprising upright members and a storage volume comprising storage columns provided between the upright members, wherein storage containers are stackable in stacks within the storage columns; wherein the second framework structure comprises a second rail system supported on the upright members of the second framework structure;
a first container handling vehicle operating on the first rail system;
a second container handling vehicle operating on the second rail system;
   wherein the automated storage and retrieval system comprises a lift arrangement according to the above;
   wherein the first container handling vehicle is loading a storage container from the first framework structure to the container carrier at the first container handling position or is unloading a storage container from the container carrier at the first container handling position to the first framework structure;
   wherein the second container handling vehicle is loading a storage container from the second framework structure to the container carrier at the second container handling position or is unloading a storage container from the container carrier at the second container handling position to the second framework structure.

In one aspect, the first container handling position is located within the first framework structure below the first rail system and wherein the second container handling position is located within the second framework structure below the second rail system.

In one aspect, an upper edge of the storage container is located immediately below the second rail system when in the second container handling position and/or wherein the upper edge of the storage container is located immediately below the first rail system when in the first container handling position.

Hence, the storage container in the first container handling position represents no obstacle for the first container handling vehicle operating on the first rail system and the first container handling vehicle may pass above the storage container in this position. In addition, the height needed to move the gripping device of the first container handling vehicle during loading/unloading is kept at a minimum.

Similarly, the storage container in the second container handling position represents no obstacle for the second container handling vehicle operating on the second rail system and the second container handling vehicle may pass above the storage container in this position. Again, the height needed to move the gripping device of the second container handling vehicle during loading/unloading is kept at a minimum.

In one aspect, the upright members of the second framework structure is supported on a floor;

wherein the lift arrangement comprises a lower supporting bar for supporting the guide relative to, and above, the floor
wherein the lower supporting bar has an height adjusted to locate the upper edge of the storage container immediately below the second rail system when in the second container handling position.

In one aspect, the lift arrangement comprises an upper supporting bar for supporting the guide relative to, and below the first rail system,

wherein the upper supporting bar has an height adjusted to locate the upper edge of the storage container immediately below the first rail system when in the first container handling position.

The present invention also relates to a method for moving storage containers between a first framework structure and a second framework structure of an automated storage and retrieval system; wherein the method comprises the steps of:
moving one of a plurality of container carriers connected to a guide to a first container handling position located within the first framework structure;
loading a storage container onto the one container carrier while the one container carrier is in the first container handling position;
moving the container carrier along the guide to a second container handling position located within the second framework structure;
unloading the storage container from the one container carrier while the one container carrier is in the second container handling position.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of the automated storage and retrieval system with the container lifting arrangement.

FIG. 6 is a side view of the automated storage and retrieval system with the container lifting arrangement.

FIG. 7a is a perspective view from above of a container carrier of the container lifting arrangement.

FIG. 7b is perspective view from below of the container carrier of the container lifting arrangement.

FIG. 7c is front view of the container carrier of the container lifting arrangement.

FIG. 8 is a simplified illustration of the cross section along line A in FIG. 7c.

FIG. 9 is an alternative embodiment of the embodiment shown in FIG. 8.

FIG. 10 illustrates an embodiment where the endless guide has one single guide member.

FIG. 11 illustrates a perspective view of a container carrier with a supporting surface allowing storage containers of different heights to be carried with their connection interface at the same height.

FIG. 12 illustrates a perspective view corresponding to FIG. 11, wherein a low-height storage container has been lifted up from the supporting surface of the container carrier.

FIG. 13 illustrates a perspective view of a container carrier with a container elevator for elevating the storage container upwardly to a desired height.

FIG. 14 illustrates a perspective view of a lift arrangement between two framework structures located on the same level.

FIG. 15 illustrates a side view of the lift arrangement in FIG. 14.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

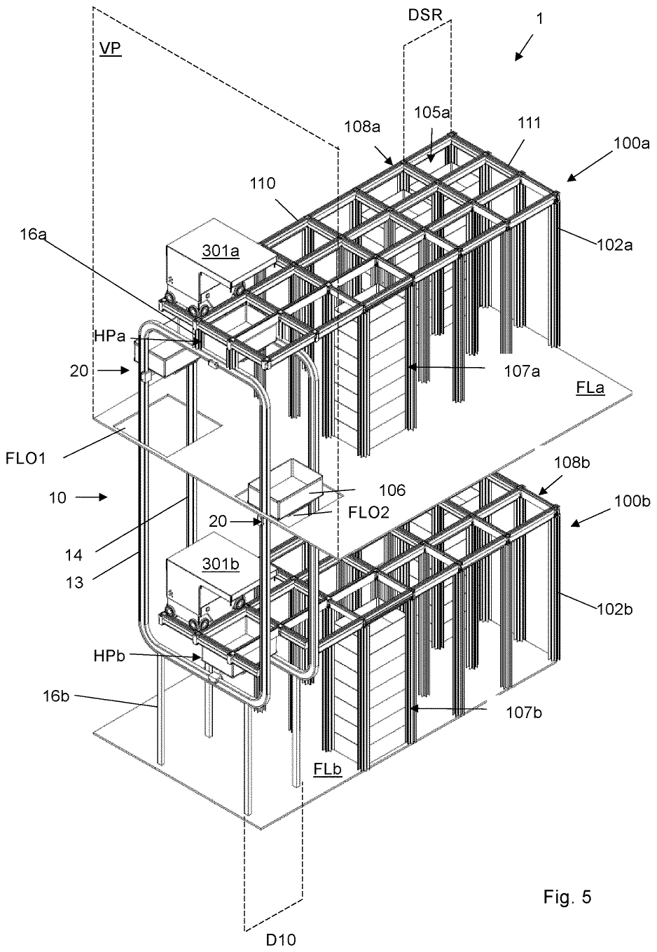

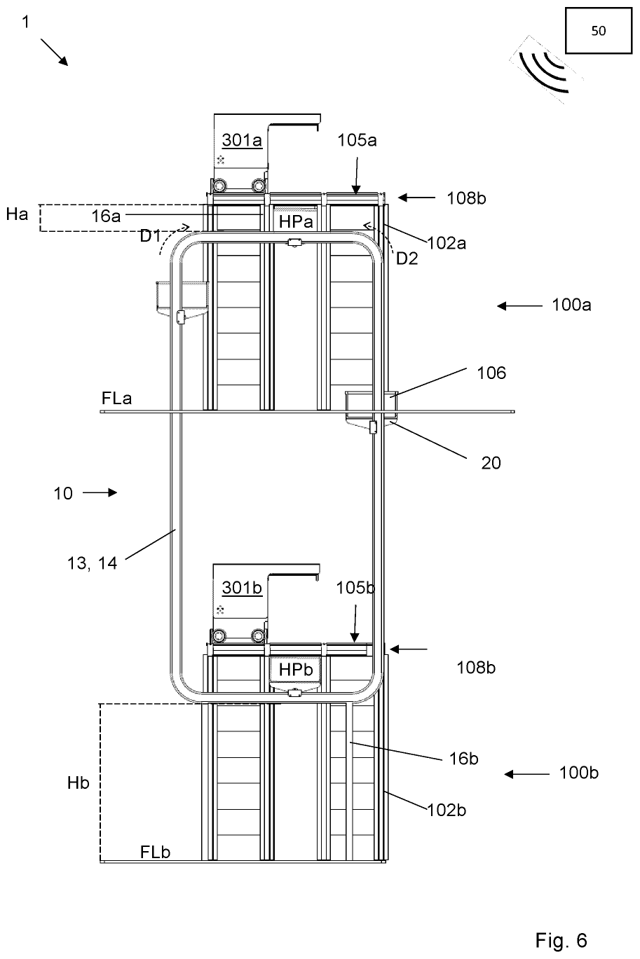

It is now referred to FIGS. 5 and 6, wherein an embodiment of the automated storage and retrieval system 1 is shown. The system 1 comprises a first framework structure 100a comprising upright members 102a and a storage volume comprising storage columns 105a provided between the upright members 102a, wherein storage containers 106 are stackable in stacks 107a within the storage columns 105a. In addition, the first framework structure 100a comprises a first rail system 108a supported on the upright members 102a of the first framework structure.

Similarly, the system comprises a second framework structure 100b comprising upright members 102b and a storage volume comprising storage columns 105b provided between the upright members 102b, wherein storage containers 106 are stackable in stacks 107b within the storage columns 105b. In addition, the second framework structure 100 comprises a second rail system 108b supported on the upright members 102b of the second framework structure.

The first framework structure 100a is located on a first floor FLa, while the second framework structure 100b is located on a second floor FLb, below the first floor FLa. Hence, the first framework structure 100a is located above the second framework structure 100b.

According to the above, the system 1 may be referred to as a multi-framework automated storage and retrieval system.

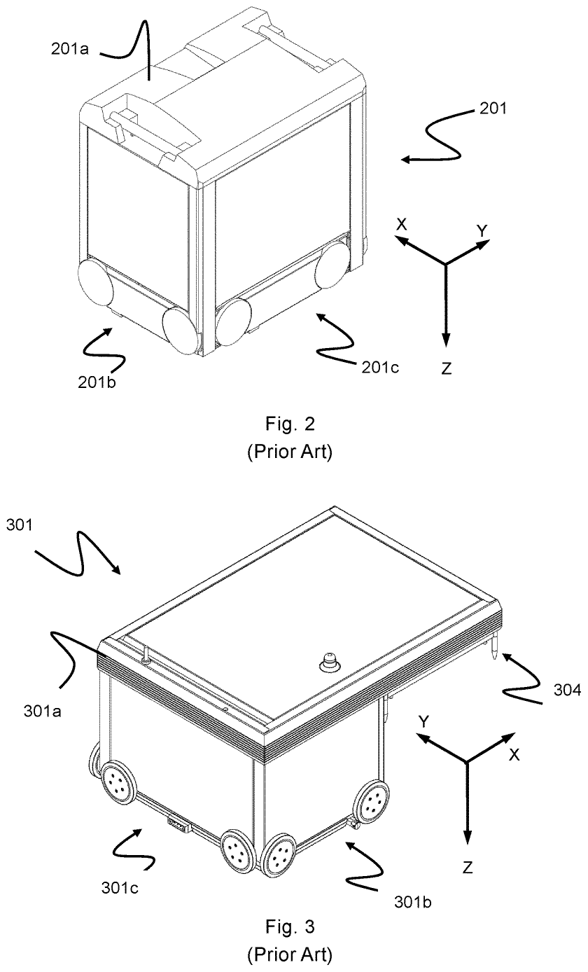

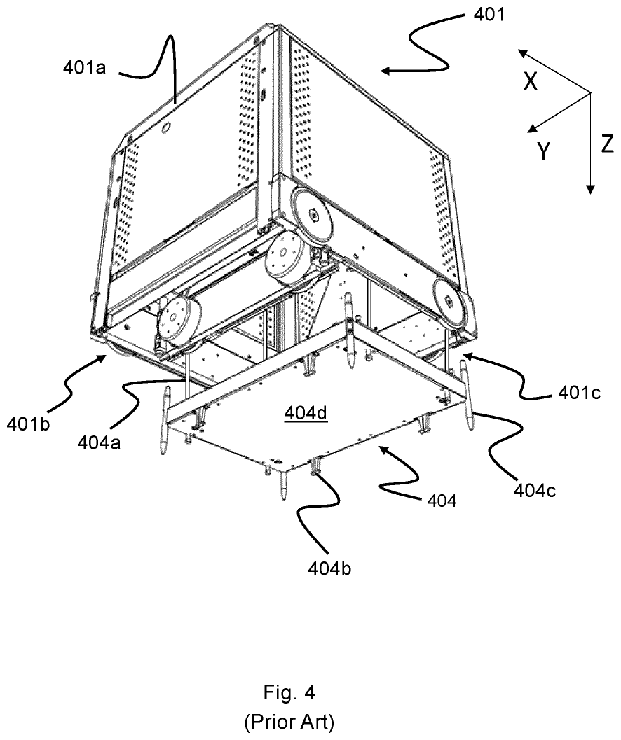

It is further shown in these drawings that the system 1 comprises a first container handling vehicle 301a operating on the first rail system 108a and a second container handling vehicle 301b operating on the second rail system 108a. It should be noted that even though the prior art cantilever type of vehicle 301 of FIG. 3 is shown in FIGS. 5 and 6, the first and second container handling vehicles may be of the prior art type shown in FIG. 2 and in FIG. 4. Other container handling vehicles may also be used. It should further be noted that the framework structures 100a, 100b can be of any size. In particular it is understood that the framework structure can be considerably wider and/or longer and/or deeper than disclosed in FIGS. 5 and 6. For example, the framework structure 100 may have a horizontal extent of more than 700×700 columns and a storage depth of more than twelve containers. The framework structures 100a, 100b may be of the prior art type of framework structure 100.

In FIGS. 5 and 6, it is further shown that the automated storage and retrieval system 1 comprises a lift arrangement 10. The purpose of the lift arrangement 10 is to move storage containers 106 between the first framework structure 100a and the second framework structure 100b. The lift arrangement 10 comprises a guide with two guide elements, a first guide member 13 and a second guide member 14 spaced apart in a horizontal direction from the first guide member 13. The lift arrangement 10 further comprises a plurality of container carriers 20 connected between the first guide member 13 and the second guide member 14. The container carriers 20 are individually movable along the guide 13, 14 between a first container handling position HPa located within the first framework structure 100a and a second container handling position HPb located within the second framework structure 100b. Preferably, the guide is an endless guide, i.e. there are no end positions at which the container carrier 20 cannot be moved further.

The first container handling vehicle 301a may load a storage container 106 retrieved from one of the storage columns 105a in the first framework structure 100a and move it to the container carrier 20 at the first container handling position HPa.

Similarly, the first container handling vehicle 301a may unload a storage container 106 from the container carrier 20 at the first container handling position HPa and move it to one of the storage columns 105a of the first framework structure 100a.

The second container handling vehicle 301b may load a storage container 106 from one of the storage columns 105b of the second framework structure 100b to the container carrier 20 at the second container handling position HPb. Similarly, the second container handling vehicle 301b may unload a storage container 106 from the container carrier 20 at the second container handling position HPb and move it to one of the storage columns 105b of the second framework structure 100.

### The Container Carrier

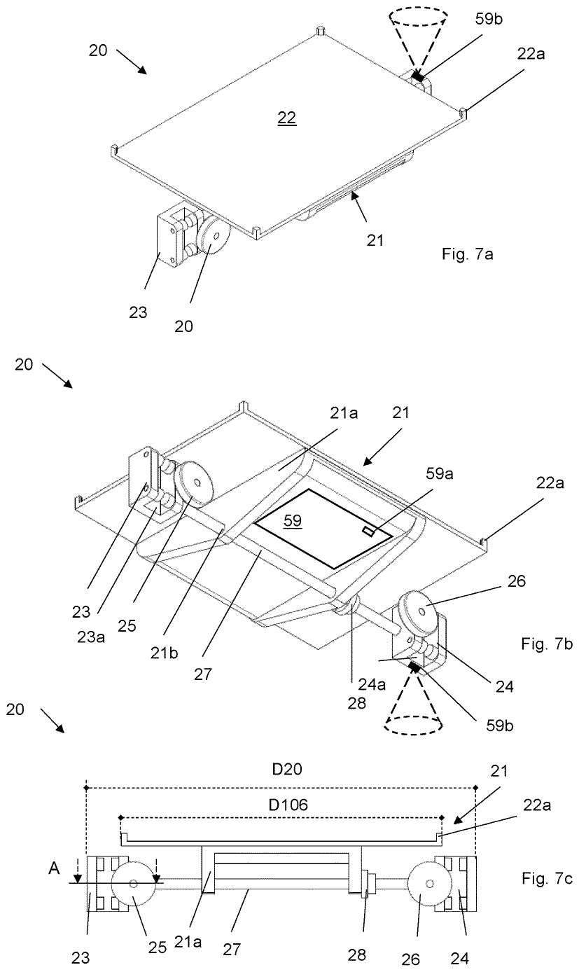

It is now referred to FIGS. 7a, 7b and 7c, where one container carrier 20 is shown in detail.

Here it is shown that the container carrier 20 comprises a main body 21 with a base 21a on which a supporting surface 22 is secured. The supporting surface 22 is configured to receive a storage container 106 and to support the storage container 106 during the movement of the container carrier 20 along the endless guide. The main body 21 is further provided with an opening 21b through the base 21a.

As shown in FIG. 7a and FIG. 7b, the supporting surface 22 comprises pegs 22a for preventing horizontal movement of the storage container 106 relative to the supporting surface 22. The pegs 22a are here corner pegs protruding upwardly from corners of the supporting surface 22 and is adapted to be received by a recess provided in each corner of the storage container 106.

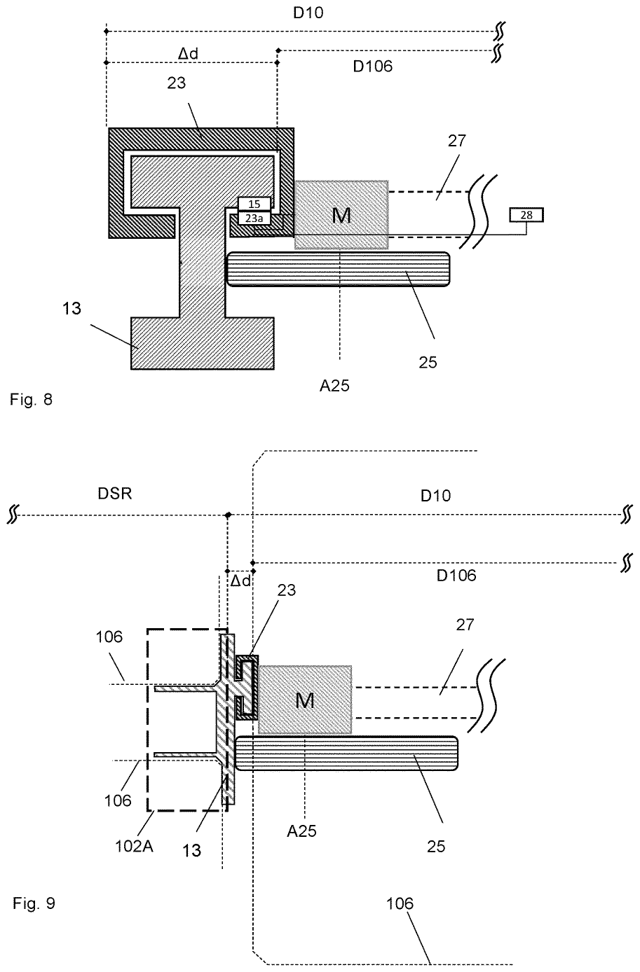

The container carrier 20 further comprises a first runner 23 and a second runner 24 connected to each other by means of an axle 27. The axle 27 is extending through the opening 21b of the main body 21. As shown in FIG. 6, FIG. 7a and FIG. 8, the first runner 23 and the second runner 24 are engaged with ends of the T-shaped or H-shaped cross-sectional profile of the respective guide members 13, 14. As shown in FIG. 8, the first runner 23 is engaged with the first guide member 13. Similarly, the second runner 24 is engaged with the second guide member 14. The runners 23, 24 allows the container carrier 20 to run along the endless guide.

The container carrier 20 further comprises a drive in the form of a powered wheel 25, 26 for moving the container carrier 20 along the endless guide. As shown in FIG. 8, the wheel 25 is rotated around a rotation axis A25 by means of a motor M. The wheel 25 is provided in contact with the first guide member 13. Hence, when rotated, the wheel 25 will move the carrier 20 relative to the guide member 13. Similarly, the wheel 26 is provided in contact with the second guide member 14 and will move the carrier 20 relative to the guide member 14.

The container carrier 20 further comprises an orientation device 28 connected between the axle 27 and the base 21a for rotating the axle 27 relative to the base 21a. In this way, the supporting surface 22 is oriented with a desired orientation during the movement of the container carrier 20 along the endless guide 13, 14. The orientation device 28 may for example be a servo motor. It should be noted that the container carrier 20 in FIGS. 7a, 7b and 7c are shown in a state in which it is following a vertical section of the endless guide, i.e. the rotation axis of the respective wheels is parallel with the supporting surface 22.

Typically, as shown in FIG. 5, the orientation device 28 is ensuring that the supporting surface 22 is maintained horizontally. However, there may be some situations where the orientation device 28 is controlling the supporting surface 22 to maintain a different orientation than a horizontal orientation.

The container carrier 20 is further comprising a carrier control system 59 configured to control the orientation device 28 and the wheels 25, 26. The carrier control system 59 may comprises a sensor 59a (see FIG. 7b) for sensing the orientation of the supporting surface 22. In addition, the carrier control system 59 may comprise a distance sensor 59b (see FIG. 7a and FIG. 7b) for measuring the distance to an adjacent container carrier 20. In FIG. 7a, the sensor 59b measures the distance to objects above the container carrier 20 (as indicated by the dashed cone), while the sensor 29b in FIG. 7b measures the distance to objects below the container carrier 20 (as indicated by the dashed cone). The sensor 29b may be a proximity sensor, such as an ultrasonic sensor, an IR sensor etc. Preferably, the sensor 29b and/or carrier control system 59 may also be capable of detecting whether the adjacent container carrier 20 is occupied with a storage container or not.

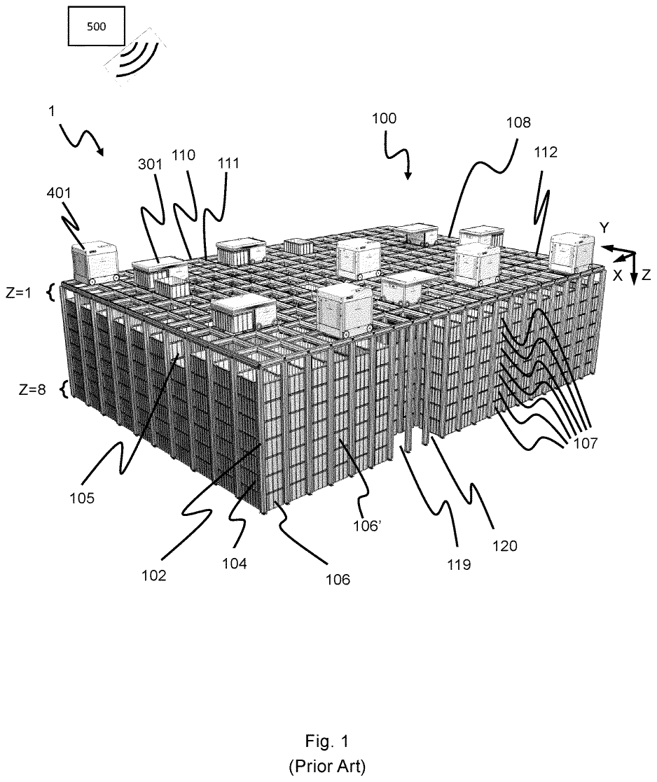

The lift arrangement 10 may further comprise a control system 50 as indicated in FIG. 6. This control system 50 may be the control system 500 of the automated storage and retrieval system 1 indicated in FIG. 1, or a separate control system 50 provided in communication with the control system 500.

The control system 50 is provided in communication with the carrier control systems 59 of the respective container carriers 20. The control system 50 may be configured to control the movement of the container carriers relative to the endless guide. Hence, the control system 50 may also be configured to prevent collision between two container carriers. However, the carrier control system 59 may also be configured to prevent collision with adjacent container carriers by means of sensors 59b.

The interface between the guide members and the runners may be used to transfer electric energy from a power source to each of the container carriers 20. This is indicated schematically in FIG. 8, where it is shown that the guide member 13 comprises an electrical contact 15 and that the runner 23 comprises an electrical pickup 23a provided in electrical contact with the electrical contact 15 during the movement of the container carrier along the guide member 13. It is also indicated in FIG. 8 that the pickup 23a is electrically connected to the motor M and to the orientation device 28.

It is now referred to FIG. 6. Here it is shown two directions D1 and D2. In the present embodiment, the container carriers 20 are moved in the first direction D1 only. However, in an alternative embodiment, it is possible that the container carriers 20 can be moved in both the first direction D1 and in a second direction D2 opposite of the first direction D1.

It should however be noted that due to the “endless” property of an endless guide, the sequence of container carriers arriving at the container handling positions HPa, HPb will be the same as long as the container carriers are moved in the first direction D1.

While one container carrier 20 is held stationary at one of, or both of, the container handling positions HPa, HPb to allow that a container 106 is unloaded from the supporting surface 22 and/or to allow that a container 106 is loaded onto the supporting surface 22, other container carriers 20 may move along the endless guide, as long as collisions between these container carriers are avoided.

According to the above, the first guide member 13 and the second guide member 14 define a path for the movement of the container carriers 20. The plurality of container carriers 20 are sequentially movable along the endless guide.

### Supporting Bars 16a, 16b

As shown in FIG. 5, the upright members of the second framework structure 100b is supported on the floor FLb. The lift arrangement 10 comprises a lower supporting bar 16b for supporting the guide 13, 14 relative to, and above, the floor FLb.

Preferably, the lower supporting bar 16b has a height Hb adjusted to locate the upper edge of the storage container 106 immediately below the second rail system 108b when in the second container handling position HPb.

It is further shown in FIG. 5 that the lift arrangement 10 comprises an upper supporting bar 16a for supporting the guide 13, 14 relative to, and below the first rail system 108a. Preferably, the upper supporting bar 16a has an height Ha adjusted to locate the upper edge of the storage container 106 immediately below the first rail system 108a when in the first container handling position HPa.

It should further be noted that in the present embodiment, the container handling positions HPa, HPb are located at a height immediately below the rail systems 108a, 108b. In the present embodiment, a storage container positioned on the supporting surface of the carrier 20 being in one of the container handling positions HPa, HPb are approximately at the same height as storage containers stored at heigh Z=1 in a stack of containers stacked in a storage column, i.e. at the uppermost layer available for storage containers below the rails of the rail systems 108a, 108b. Container handling vehicles 301 may move along the rail system 108 above the storage container stored in the container handling positions HPa, HPb. Still, the container handling vehicle 301 is lifting/lowering the container 106 a very short vertical distance for every unloading and unloading.

In FIG. 7c, a width D20 of a container carrier 20 is indicated. Also a width D106 of the storage container 106 is indicated here. In FIG. 5, the width D10 of the lift arrangement is also indicated, together as a width DSR. The width DSR is here defined as the distance between the centre axis of two adjacent upright members 102. Of course, as the containers 106 are rectangular, the width D20 of the carrier 20, the width D106 of the container 106, the width D10 of the lift arrangement 10 and the width DSR of a storage row should be measured in the same direction.

Hence, it is not possible to stack storage containers 106 in stacks adjacent to the lift arrangement, causing the lift arrangement to have a footprint width of two storage columns in the case of the lift arrangement being located in one end of a storage system 1, as shown in FIG. 4. This is caused by the relative large difference between the width D10 of the lift arrangement and the width D106 indicated as difference Δd in FIG. 8. Of course, the total difference in width will be 2*Δd.

An alternative embodiment is shown in FIG. 9. Here, the difference Ad is much smaller. Moreover, the T-shaped profile of the endless guide 13 is here integrated with, or secured to, a half-section 102A of an upright member 102a, 102b. As is known from prior art, an upright member 102 is normally guiding corners of four storage containers during their vertical movement up and down the storage columns. The half-section 102a is supporting corners of two storage containers, as indicated by dashed lines 106.

In FIG. 9, parts of the widths DSR, D20 and D106 are also indicated, together with the above smaller distance Ad. In this embodiment, the width D10 of the lift arrangement 10 is equal to the width DSR of a storage row of the automated storage and retrieval system 1, and hence, storage containers 106 may be stacked adjacent to the lift arrangement 10. The lift arrangement here has a footprint width of one storage column.

The above lift arrangement 10 ensures that a storage container 106 can be loaded onto the container carrier 20 while the one container carrier 20 is in the first container handling position HPa located within the first framework structure 100a. The container carrier 20 is then moved along the guide 13, 14 to the second container handling position HPb located within the second framework structure 100b, wherefrom the storage container 106 is unloaded from the one container carrier 20 while the one container carrier 20 is in the second container handling position HPb.

### Alternative Embodiments

In one alternative embodiment, the powered wheel 25, 26 is used also for the purpose of connecting the main body 21 to the endless guide 13, 14. Hence, the runners are not essential.

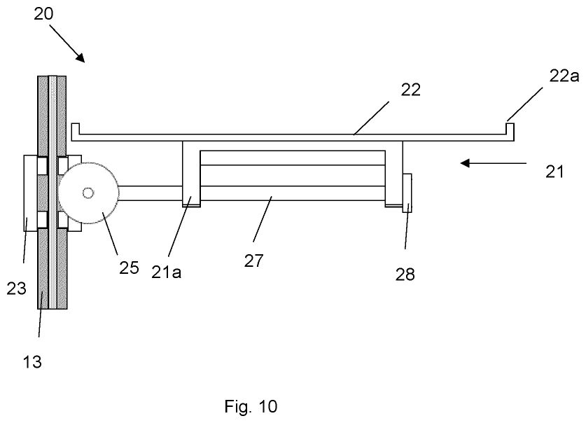

It is now referred to FIG. 10. Here it is shown an embodiment of the container carrier 20 has only one runner 23 and only one powered wheel 25. In this embodiment, the endless guide comprises only one guide member 13. This embodiment is particularly suitable if the weight of the content of the storage container 106 is relatively smaller.

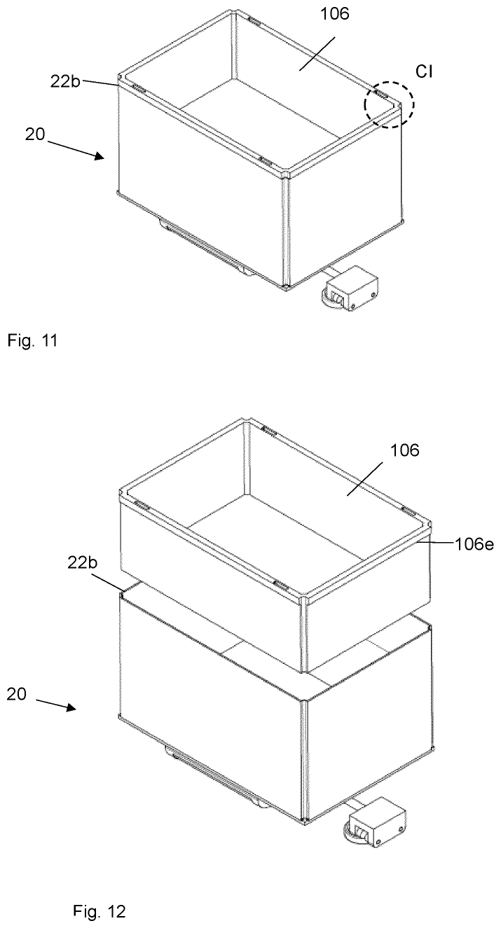

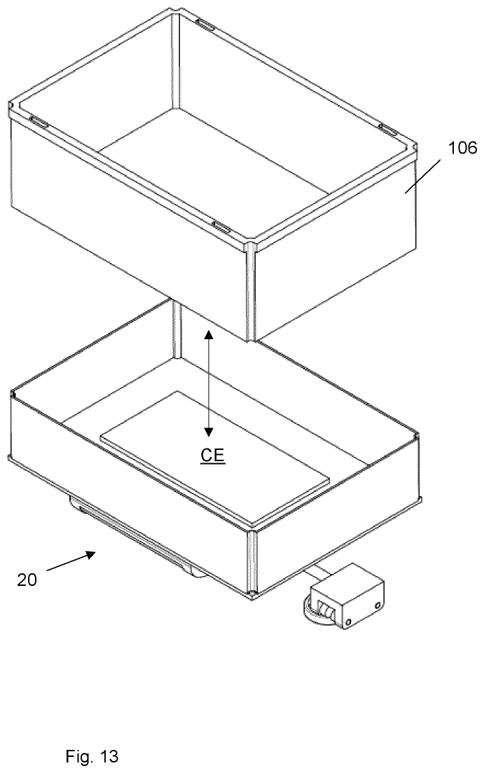

It is now referred to FIG. 11. Here it is shown that the supporting surface 22 is formed as a rim 22b for supporting an upper part of the storage containers 106. Some automated storage and retrieval systems are using storage containers of different heights, typically referred to as “short” and “tall” containers. By providing the supporting surface 22 as a rim 22b, both types of storage containers can be supported with their connection interface CI at the same height when carried by the container carrier. On advantage is that the distance and time of movement of the gripper device towards and away from the “short” storage containers becomes equal to the “tall” container. Another advantage is that when the connection interface CI in this way can be located immediately below the rail systems 108a, 108b for all container types, the gripper device can be guided by the access openings 112 between the rails 110, 111 of the rail system, and hence, the risk of the gripper device to be misaligned relative to the short containers becomes reduced. The rim 22b is formed by an upper surface of four side walls protruding up from the main body 21 of the container carrier 20. The storage containers may here comprise an upper edge 106e (FIG. 12) protruding out from the top of the storage container. The four side walls of the container handler forms a space in which all of the container can be inserted, except from the upper edge 106e, which will rest on top of the rim 22b.

FIG. 12 shows how a short container is lifted up from the rim 22b. It is here shown that a taller container can be supported by the same rim 22b.

It is now referred to FIG. 13. Here it is shown that the container carrier 20 comprises four side walls protruding up from the may body 21. The container carrier 20 here comprises a container elevator CE for elevating the storage container upwardly to a desired height. Again, the purpose is to reduce distance and time of movement of the gripper device towards and away from the “short” storage containers and to reduce the risk of the gripper device becoming misaligned relative to the short containers.

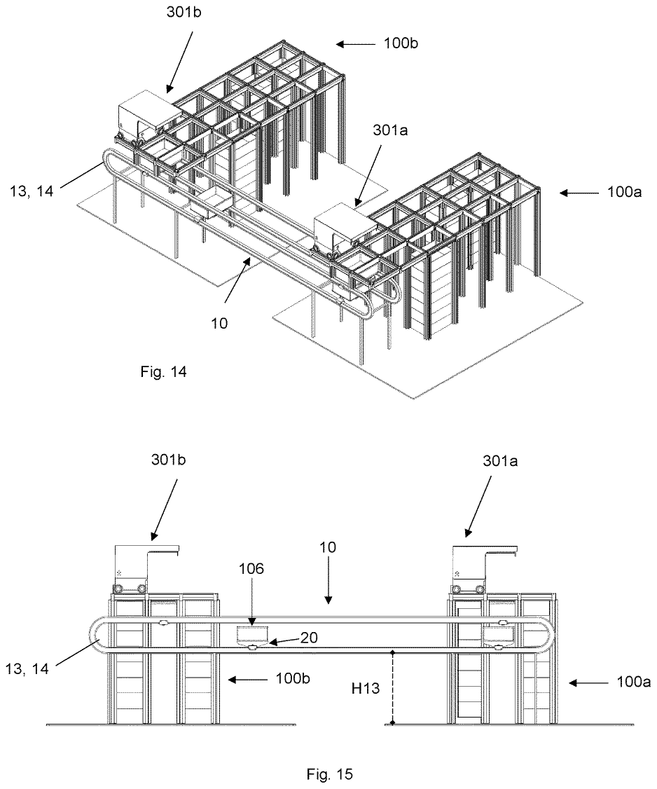

It is now referred to FIG. 14 and FIG. 15. Here it is shown that the first framework structure 100a and the second framework structure 100b are on the same horizontal level. The lift arrangement 10 is here moving storage containers between framework structures located at the same height. A height H13 indicated in FIG. 15 between the floor level and the lowermost part of the guide 13 will typically be so large that the guide will not obstruct people and/or vehicles such as automated guided vehicles (AGVs), autonomous mobile robots (AMRs), forklifts etc. to move on the floor below the guide 13.

In the preceding description, various aspects of the lift arrangement and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 retrieval system
10 lift arrangement
13 guide, first guide member
14 second guide member
15 electrical contact
16a upper supporting bar
16b lower supporting bar
20 container carriers
21 main body
21a base
21b opening
22 supporting surface
22a pegs
22 rim
23 first runner
23a electrical pickup
24 second runner
24a electrical pickup
25 drive, powered wheel
26 drive, powered wheel
27 axle
28 orientation device
29b sensor
50 control system
59 carrier control system
59a sensor
59b distance sensor
100 framework structure
100a first framework structure
100b second framework structure
102 upright members
102A half-section of upright members
102a First upright members
102b Second upright members
104 grid
105 storage columns
105a storage columns
105b storage columns
106 storage containers
106′ storage container
106e edge of storage container
10 stacks
107a stacks
107b stacks
108 rail system
108a first rail system
108b second rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
FLa first floor
FLb second floor
HPa first container handling position
HPb second container handling position

1. A lift arrangement for moving storage containers between a first framework structure and a second framework structure of an automated storage and retrieval system, wherein the lift arrangement comprises:
a guide extending between at least the first framework structure and the second framework structure, wherein the guide comprises a first container handling position located within the first framework structure and a second container handling position located within the second framework structure; and
a plurality of container carriers individually movable along the guide between the first container handling position and the second container handling position.

2. (canceled)

3. The lift arrangement according to claim 1, wherein the guide is an endless guide.

4. (canceled)

5. The lift arrangement according to claim 3, wherein the endless guide comprises a first guide member and a second guide member spaced apart in a horizontal direction from the first guide member, wherein the plurality of container carriers are connected between the first guide member and the second guide member.

6. The lift arrangement according to claim 1, wherein each of the plurality of container carriers comprises:
a supporting surface for supporting a storage container;
a drive for moving the supporting surface along the guide;
an orientation device for orienting the supporting surface with respect to the drive during movement of the container carrier along the guide.

7. The lift arrangement according to claim 6, wherein each of the plurality of container carriers comprises a carrier control system for controlling the orientation device and the drive.

8. The lift arrangement according to claim 6, wherein each of the plurality of container carriers comprises a runner for connecting the supporting surface to the guide.

9. The lift arrangement according to claim 8, wherein the guide comprises an electrical contact wherein the runner comprises an electrical pickup provided in electrical contact with the electrical contact, and wherein the drive and/or the orientation device are supplied with electrical power via the electrical pickup and the electrical contact.

10. The lift arrangement according to claim 7, wherein the carrier control system of each container carrier is configured to control its associated orientation device to keep the supporting surface in a horizontal orientation during movement of the container carrier around the guide, the guide being an endless guide.

11. The lift arrangement according to claim 8, wherein each of the plurality of container carriers comprises:
an axle extending between a first runner and a second runner, wherein the supporting surface is arranged to pivot around the axle by means of the orientation device.

12. (canceled)

13. The lift arrangement according to claim 6, wherein the supporting surface comprises pegs for preventing horizontal movement of the storage container relative to the supporting surface.

14. The lift arrangement according to claim 6, wherein the supporting surface is formed as a rim for supporting an upper part of the storage containers, thereby allowing storage containers of different heights to be supported at a same level.

15. The lift arrangement according to claim 6, wherein the container carrier comprises a container elevator for elevating the storage container upwardly to a desired height.

16. (canceled)

17. The lift arrangement according to claim 7, wherein the lift arrangement comprises:
a control system provided in communication with the carrier control system of each of the plurality of container carriers, wherein the control system is configured to prevent collision between the plurality of container carriers.

18. The lift arrangement according to claim 7, wherein the carrier control system is configured to stop the movement of the container carrier at the first container handling position and at the second container handling position while moving other container carriers along the guide, the guide being an endless guide.

19. An automated storage and retrieval system comprising:
a first framework structure comprising upright members and a storage volume comprising storage columns provided between the upright members, wherein storage containers are stackable in stacks within the storage columns; wherein the first framework structure comprises a first rail system supported on the upright members of the first framework structure;
a second framework structure comprising upright members and a storage volume comprising storage columns provided between the upright members, wherein storage containers are stackable in stacks within the storage columns; wherein the second framework structure comprises a second rail system supported on the upright members of the second framework structure;
a first container handling vehicle operating on the first rail system;
a second container handling vehicle operating on the second rail system;
wherein the automated storage and retrieval system comprises a lift arrangement according to claim 1;
wherein the first container handling vehicle is loading a storage container from the first framework structure to a container carrier at a first container handling position or is unloading a storage container from the container carrier at the first container handling position to the first framework structure;
wherein the second container handling vehicle is loading a storage container from the second framework structure to a container carrier at the a second container handling position or is unloading a storage container from the container carrier at the second container handling position to the second framework structure

20. (canceled)

21. The automated storage and retrieval system according to claim 19, wherein the first container handling position is located within the first framework structure below the first rail system and wherein the second container handling position is located within the second framework structure below the second rail system.

22. The automated storage and retrieval system according to claim 21, wherein an upper edge of the storage container is located immediately below the second rail system when in the second container handling position and/or wherein the upper edge of the storage container is located immediately below the first rail system when in the first container handling position.

23. The automated storage and retrieval system according to claim 22, wherein the upright members of the second framework structure is supported on a floor;
wherein the lift arrangement comprises a lower supporting bar for supporting the guide relative to, and above, the floor; and
wherein the lower supporting bar has a height adjusted to locate the upper edge of the storage container immediately below the second rail system when in the second container handling position.

24. The automated storage and retrieval system according to claim 22,
wherein the lift arrangement comprises an upper supporting bar for supporting the guide relative to, and below the first rail system, and
wherein the upper supporting bar has a height adjusted to locate the upper edge of the storage container immediately below the first rail system when in the first container handling position.

25. A method for moving storage containers between a first framework structure and a second framework structure of an automated storage and retrieval system; wherein the method comprises:
moving one container carrier of a plurality of container carriers connected to a guide to a first container handling position located within the first framework structure;
loading a storage container onto the one container carrier while the one container carrier is in the first container handling position;
moving the one container carrier along the guide to a second container handling position located within the second framework structure; and
unloading the storage container from the one container carrier while the one container carrier is in the second container handling position.
